(19) United States
(12) Patent Application Publication
(10) Pub. No.: US 2012/0162910 A1
(43) Pub. Date: Jun. 28, 2012

(54) DATA PROCESSING APPARATUS AND POWER CONNECTION MECHANISM AND METHOD THEREOF

(75) Inventor: Ben-Chiao Jai, Taoyuan Hsien (TW)

(73) Assignee: DELTA ELECTRONICS, INC., Taoyuan Hsien (TW)

(21) Appl. No.: 13/076,193

(22) Filed: Mar. 30, 2011

(30) Foreign Application Priority Data
Dec. 23, 2010 (TW) 099145648

(51) Int. Cl. G06F 1/16

(52) U.S. Cl. 361/679.58

(57) ABSTRACT

A data processing apparatus includes a rack cabinet, a power distribution unit, at least one auxiliary fixing device and at least one modular electronic device. The rack cabinet includes a frame assembly and a receiving part. The power distribution unit is disposed on a frame body of the frame assembly, and includes a plurality of power cords and a plurality of first electric connectors. The power cords are connected with respective first electric connectors. The auxiliary fixing device is used for assisting in positioning a corresponding first electric connector at a specified location of the supporting rod. The modular electronic device includes a second electric connector and swappable to be accommodated within a corresponding compartment of the receiving part. After the modular electronic device is accommodated within the compartment, the second electric connector is connected with the corresponding first electric connector of the power distribution unit in a blind-mating manner.

### FIELD OF THE INVENTION

The present invention relates to a data processing apparatus, and more particularly to a data processing apparatus capable of connecting a modular electronic device with a power distribution unit in a blind-mating manner. The present invention relates to a power connection mechanism of the data processing apparatus.

### BACKGROUND OF THE INVENTION

With increasing development of information industries and networks, the services provided through networks are becoming more and more popular in various applications. A data center is a facility used to house computers or servers. For providing intensive network applications, the numbers of computers or servers of the data center need to be increased to transmit, process, access and communicate data at high speed.

Nowadays, the data center comprises a plurality of data processing apparatuses. Each data processing apparatus comprises a rack cabinet and a plurality of modular electronic devices. The rack cabinet has a receiving part for accommodating these modular electronic devices. FIG. 1A schematically illustrates a rack cabinet and a power distribution unit of a data processing apparatus according to the prior art. FIG. 1B schematically illustrates the connection between the modular electronic device and the power distribution unit through a power cord according to the prior art. Generally, at least one power distribution unit (PDU) 11 is installed on an inner surface of the rack cabinet 10 of the data processing apparatus 1. The power distribution unit 11 is configured for distributing external electric power to a plurality of modular electronic devices 12. Generally, the modular electronic devices 12 of the data processing apparatus 1 are computers or servers that are acquired from several different manufacturers. As known, for providing power to the modular electronic devices 12, the electric connectors of the power cords 13 are dependent on the types of the modular electronic devices 12. In addition, since these modular electronic devices 12 are acquired from several different manufacturers, the electric connectors of the modular electronic devices 12 are not usually aligned with each other in a line. Moreover, for installing the modular electronic devices 12 in the rack cabinet 10 of the data processing apparatus 1, the same number of power cords 13 as the modular electronic devices 12 will be employed. Since the electric connectors of the power cords 13 are not completely identical, it is difficult and costly to manage and purchase the power cords.

Moreover, for arranging the data processing apparatuses in the data center, many factors such as heat-dissipating efficacy, space utilization, and ease of management and maintenance should be taken into consideration. Generally, after the modular electronic devices 12 are installed within the rack cabinet 10 of the data processing apparatus 1, the modular electronic devices 12 are connected with the power distribution unit 11 through the power cords 13 at the backside of the rack cabinet 10. Then, the whole data processing apparatus 1 is moved to a specified location of the data center to enhance the space utilization and the heat-dissipating efficacy. However, some drawbacks occur during the process of maintaining the data processing apparatus 1. For example, in a case that the regular maintenance of the modular electronic device 12 (e.g. a computer or a server) is made or the modular electronic device 12 needs to be replaced, since the working space in the backside of the rack cabinet 10 is usually very narrow, the rack cabinet 10 should be moved to expand the working space to allow the worker to detach the power cords 13. Until the power cords 13 between the power distribution unit 11 and the modular electronic devices 12 are detached, the worker may withdraw the modular electronic devices 12 to perform the maintenance task or replace the modular electronic devices 12. From the above discussions, it is inconvenient, time-consuming and labor-intensive to perform the maintenance task of the data processing apparatus and replace the modular electronic devices.

### SUMMARY OF THE INVENTION

The present invention provides a data processing apparatus and power connection mechanism and method for obviating the problems of installing a plurality of modular electronic devices acquired from different manufacturers. Consequently, it is not necessary to move the rack cabinet to detach the power cords during the process of maintaining or replacing the modular electronic device.

The present invention also provides a data processing apparatus capable of adaptively adjusting the location of an auxiliary fixing device according to the location of the electric connector of the modular electronic device, so that a corresponding electric connector is connected with the electric connector of the modular electronic device in a blind-mating manner. Consequently, it is labor-saving and time-saving to install and maintain the data processing apparatus.

In accordance with an aspect of the present invention, there is provided a data processing apparatus. The data processing apparatus includes a rack cabinet, a power distribution unit, at least one auxiliary fixing device and at least one modular electronic device. The rack cabinet includes a frame assembly and a receiving part. The frame assembly includes a frame body and at least one supporting rod. The power distribution unit is disposed on the frame body of the frame assembly, and includes a plurality of power cords and a plurality of first electric connectors. The power cords are connected with respective first electric connectors. The auxiliary fixing device is used for assisting in positioning a corresponding first electric connector at a specified location of the supporting rod. The modular electronic device includes a second electric connector and swappable to be accommodated within a corresponding compartment of the receiving part. After the modular electronic device is accommodated within the compartment, the second electric connector is connected with the corresponding first electric connector of the power distribution unit.

In accordance with another aspect of the present invention, there is provided a power connection mechanism of a data processing apparatus. The data processing apparatus includes a rack cabinet with a frame assembly and a receiving part. The frame assembly includes a frame body and at least one supporting rod. The power connection mechanism includes a power distribution unit, at least one auxiliary fixing device and at least one modular electronic device. The power distribution unit is disposed on the frame body of the frame assembly, and includes a plurality of power cords and a plurality of first electric connectors. The power cords are connected with respective first electric connectors. The auxiliary fixing device is used for assisting in positioning a corresponding first electric connector at a specified location of the supporting rod. The modular electronic device includes a second electric connector and swappable to be accommodated within a corresponding compartment of the receiving part. After the modular electronic device is accommodated within the compartment, the second electric connector is connected with the corresponding first electric connector of the power distribution unit in a blind-mating manner.

In accordance with another aspect of the present invention, there is provided a power connection method. The power connection method comprises the steps of providing a rack cabinet, at least one auxiliary fixing device, a power distribution unit and at least one modular electronic device, wherein the rack cabinet comprises a frame assembly and a receiving part, the frame assembly comprises a frame body and at least one supporting rod, the power distribution unit is disposed on the frame body of the frame assembly and comprises a plurality of power cords and a plurality of first electric connectors, the power cords are connected with respective first electric connectors, the auxiliary fixing device is configured for assisting in positioning a corresponding first electric connector at a specified location of the supporting rod, and the modular electronic device comprises a second electric connector; and accommodating the modular electronic device within the rack cabinet, and allowing the second electric connector of the modular electronic device to be connected with the corresponding first electric connector of the power distribution unit.

The above contents of the present invention will become more readily apparent to those ordinarily skilled in the art after reviewing the following detailed description and accompanying drawings, in which:

### BRIEF DESCRIPTION OF THE DRAWINGS

FIG. 1A schematically illustrates a rack cabinet and a power distribution unit of a data processing apparatus according to the prior art;

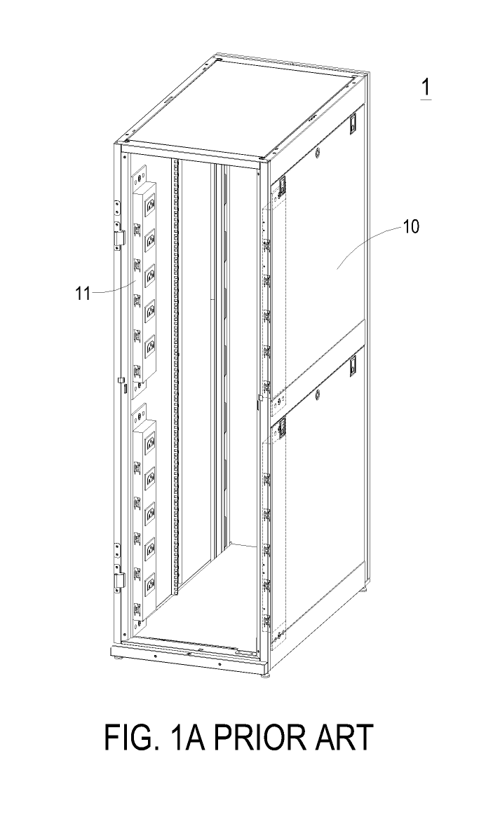

FIG. 1B schematically illustrates the connection between the modular electronic device and the power distribution unit through a power cord according to the prior art;

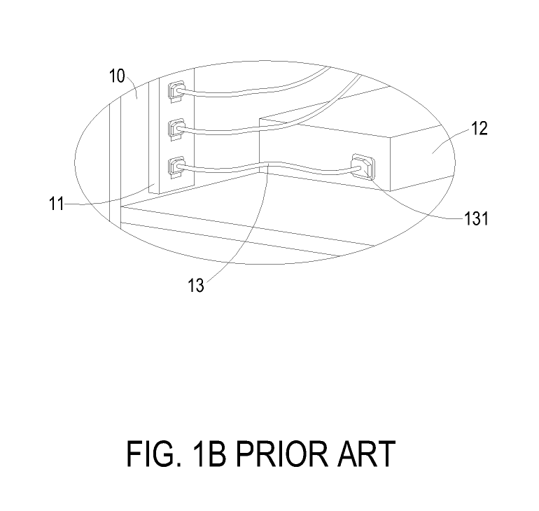

FIG. 2A is a schematic perspective view illustrating a data processing apparatus according to an embodiment of the present invention;

FIG. 2B is a schematic perspective view illustrating a variant of the data processing apparatus of FIG. 2A;

FIG. 3A schematically illustrates a power connection mechanism of the data processing apparatus of FIG. 2;

FIG. 3B schematically illustrates the connection between the modular electronic device and the power distribution unit through the power connection mechanism of FIG. 2;

FIG. 4A is schematic rear view illustrating the auxiliary fixing device and the support rod of the data processing apparatus according to an embodiment of the present invention;

FIG. 4B is schematic front view illustrating the auxiliary fixing device and the support rod of FIG. 4A;

FIG. 5A is schematic rear view illustrating the auxiliary fixing device and the support rod of the data processing apparatus according to another embodiment of the present invention;

FIG. 5B is schematic front view illustrating the auxiliary fixing device and the support rod of FIG. 5A;

FIG. 6A schematically another exemplary auxiliary fixing device and the corresponding support rod according to an embodiment of the present invention;

FIG. 6B schematically a further exemplary auxiliary fixing device and the corresponding support rod according to an embodiment of the present invention; and

FIG. 7 is a flowchart illustrating a power connection method of the data processing apparatus according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

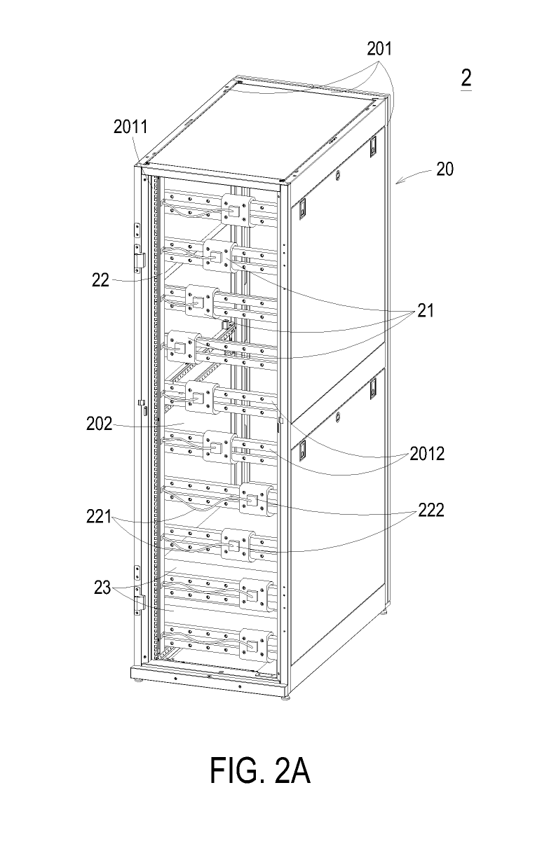

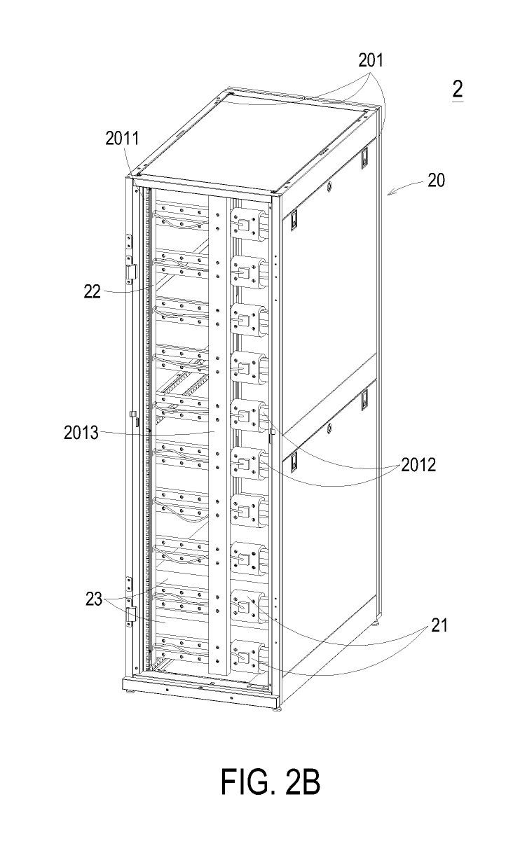

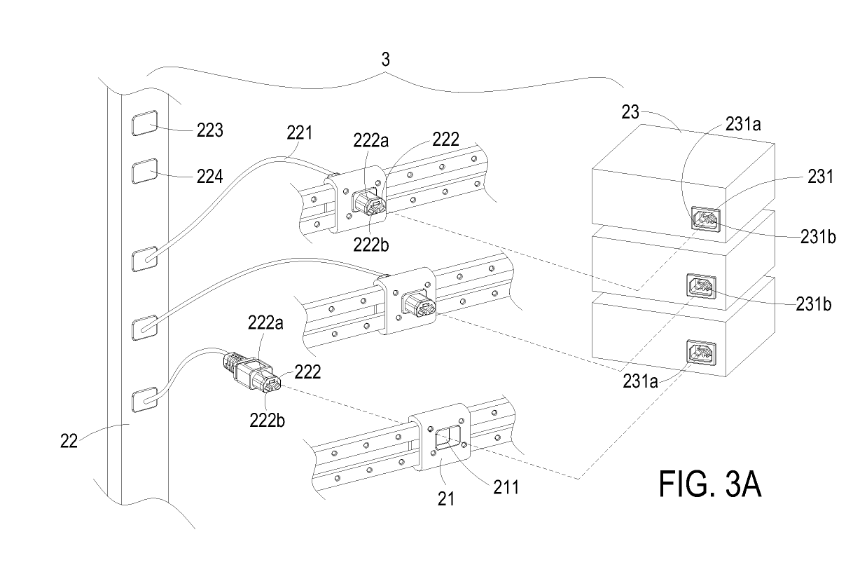

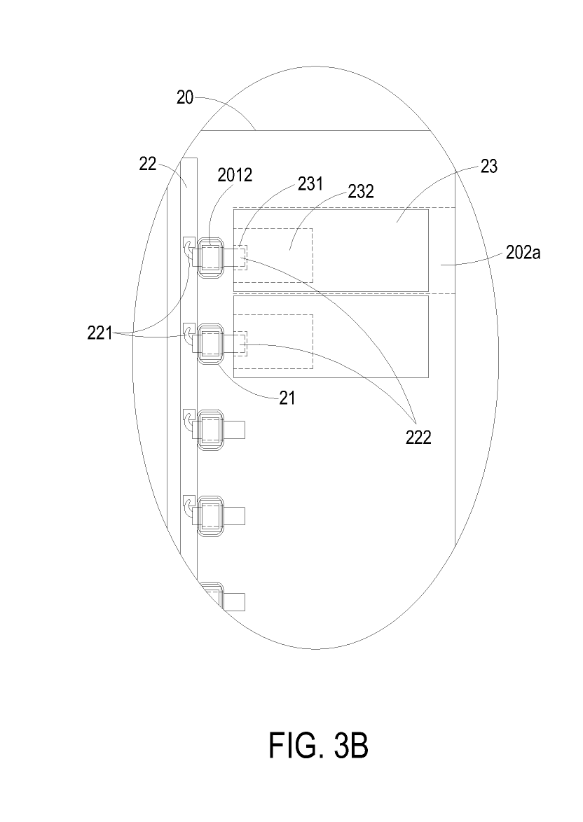

FIG. 2A is a schematic perspective view illustrating a data processing apparatus according to an embodiment of the present invention. FIG. 3A schematically illustrates a power connection mechanism of the data processing apparatus of FIG. 2. FIG. 3B schematically illustrates the connection between the modular electronic device and the power distribution unit through the power connection mechanism of FIG. 2. Please refer to FIGS. 2, 3A and 3B. The data processing apparatus 2 comprises a rack cabinet 20, one or more auxiliary fixing devices 21, a power distribution unit 22 and one or more modular electronic devices 23. Examples of the modular electronic devices 22 include but are not limited to computers or servers. The rack cabinet 20 comprises a frame assembly 201 and a receiving part 202. The frame assembly 201 comprises a frame body 2011 and one or more supporting rods 2012. The receiving part 202 comprises a plurality of compartments 202a for accommodating corresponding modular electronic devices 23. The power distribution unit 22 is disposed on the frame assembly 201 of the rack cabinet 20. It is preferred that the power distribution unit 22 is fixed on the frame body 2011 of the frame assembly 201. The power distribution unit 22 comprises a plurality of power cords 221 and a plurality of first electric connectors 222. In this embodiment, each power cord 221 has a first end connected with a corresponding first electric connector 222 and a second end connected with the power distribution unit 22. In some embodiments, the first end of each power cord 221 is connected with another electric connector (not shown), which fits a corresponding socket (not shown) of the power distribution unit 22. The auxiliary fixing device 21 is used for assisting in positioning a corresponding first electric connector 222 at a specified location of a corresponding supporting rod 2012. It is noted that the specified location of the supporting rod 2012 may be adjusted according to the location of the power supply unit 232 of a corresponding modular electronic device 23 and/or the corresponding first electric connector 222.

Moreover, the auxiliary fixing device 21 has a perforation 211. The first electric connector 222 is detachably mounted in the perforation 211 of the auxiliary fixing device 21. Each auxiliary fixing device 21 and the corresponding supporting rod 2012 are aligned with a compartment 202a of the rack cabinet 20. Each of the modular electronic devices 23 comprises a second electric connector 231 and a power supply unit 232. In addition, the modular electronic device 23 is accommodated within a corresponding compartment 202a. The second electric connector 231 mates with a corresponding first electric connector 222. After a modular electronic device 23 is accommodated within a corresponding compartment 202a of the rack cabinet 20, the second electric connector 231 of the modular electronic device 23 is swappable to be plugged in a corresponding first electric connector 211 of the power distribution unit 21. The power distribution unit 22 and the modular electronic devices 23 of the data processing apparatus 2 are defined as a power connection mechanism 3. Through the power connection mechanism 3, the modular electronic devices 23 can be plugged into the power distribution unit 22 within the rack cabinet 20 in a blind-mating manner without the need of using the power cords.

FIG. 2B is a schematic perspective view illustrating a variant of the data processing apparatus of FIG. 2A. Please refer to FIGS. 2B and 3. For increasing the structure strength of the supporting rods 2012 and the frame body 2011, the frame assembly 201 further comprises at least one supporting post 2013. The supporting post 2013 is fixed on the frame body 2011 of the frame assembly 201 and perpendicular to the supporting rods 2012. When the modular electronic device 23 is connected with the power distribution unit 22 within the rack cabinet 20 in a blind-mating manner, the supporting post 2013 may enhance the mechanical strength of the frame assembly 20 to prevent deformation of the frame body 2011 and the supporting rods 2012. In such way, the use life of the power connection mechanism 3 is prolonged.

Please refer to FIGS. 3A and 3B again. In this embodiment, the first electric connectors 222 and the second electric connectors 231 comply with the IEC (International Electrotechnical Commission) specifications. For example, the first electric connector 222 is an IEC C13 connector, and the second electric connector 231 is an IEC C14 connector. Alternatively, the first electric connector 222 is an IEC C13 connector with a pin insulation structure and/or a detecting pin, and the second electric connector 231 is an IEC C14 connector with another pin insulation structure and/or another detecting pin. It is noted that the first electric connector 222 and the second electric connector 231 may be any two kinds of connectors that fit each other. For example, the first electric connector 222 and the second electric connector 231 are the IEC C15 connector and the IEC C16 connector, respectively. Moreover, one or both of the first electric connector 222 and the second electric connector 231 have guiding parts such as bevel profiles. For example, a first guiding part 222a is formed on a housing of the first electric connector 222, a second guiding part 222b is formed on an insertion slot of the first electric connector 222, a third guiding part 231a is formed on a housing of the second electric connector 231, and/or a fourth guiding part 231b is formed on a conductive terminal of the second electric connector 231. The guiding parts can facilitate easy connection between the first electric connector 222 and the second electric connector 231 in a blind-mating manner.

Please refer to FIGS. 3A and 3B again. In some embodiments, the power distribution unit 22 further comprises a communication module 223 and a controlling module 224. Through the communication module 223, the data processing apparatus 2 can be in communication with a remote controlling device through the internet. The controlling module 224 is configured to control and manage the power distribution status and the power supply status of the power distribution unit 22. In other words, the functions of remotely controlling and managing power can be implemented by means of the communication module 223 and the controlling module 224.

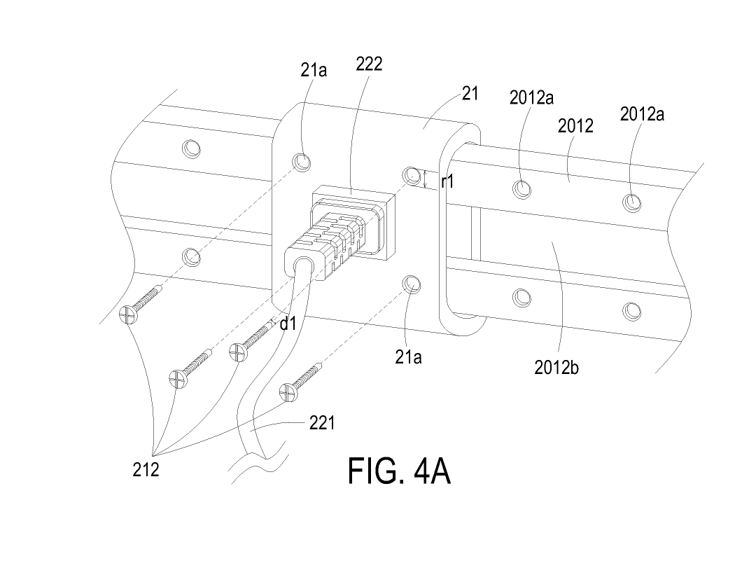

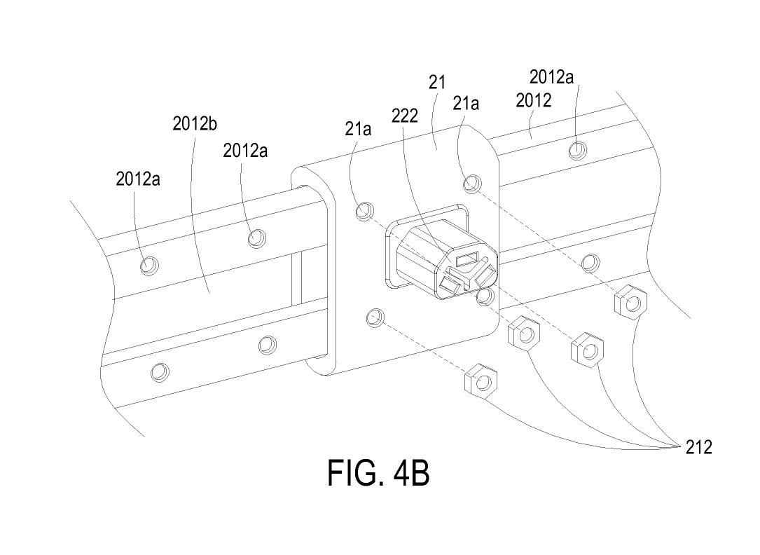

FIG. 4A is schematic rear view illustrating the auxiliary fixing device and the support rod of the data processing apparatus according to an embodiment of the present invention. FIG. 4B is schematic front view illustrating the auxiliary fixing device and the support rod of FIG. 4A. Please refer to FIGS. 4A and 4B. The auxiliary fixing device 21 is movable on the support rod 2012 in a horizontal direction. The auxiliary fixing device 21 is ring-shaped, slab-shaped, block-shaped or C-shaped. The auxiliary fixing device 21 comprises a plurality of fixing elements 212. The fixing element 212 is a screw, a screw/nut, a rivet or a fastener. After the fixing element 212 is penetrated through and tightened in a corresponding fixing hole 21a of the auxiliary fixing device 21 and a corresponding fixing hole 2012a, the auxiliary fixing device 21 is positioned at a specified location of the supporting rod 2012. The supporting rod 2012 has a plurality of fixing holes 2012a. Through the fixing holes 2012a, the location of the auxiliary fixing device 21 relative to the supporting rod 2012 in the horizontal direction is adjustable. In some embodiments, the supporting rod 2012 has an elongated slot 2012b. The first electric connector 222 is penetrated through the elongated slot 2012b. In an embodiment, the diameter r1 of the fixing hole 212a of the auxiliary fixing device 21 is greater than the outer diameter d1 of the fixing element 212 (i.e. r1>d1). As a consequence, the location of the auxiliary fixing device 21 relative to the supporting rod 2012 in the vertical direction is adjustable. In such way, the location of the auxiliary fixing device 21 may be adaptively adjusted during the process of connecting the electric connectors, thereby providing a tolerance and reducing the possibility of damaging the electric connectors. In some embodiments, the auxiliary fixing device 21 is movably disposed on the supporting rod 2012. In such way, the location of the auxiliary fixing device 21 may be adaptively adjusted during the process of connecting the electric connectors, thereby providing a tolerance and reducing the possibility of damaging the electric connectors.

From the above discussions, through the guiding parts 222a, 222b, 231a and 231b, the power connection mechanism 3 can facilitate easy connection between the first electric connector 222 and the second electric connector 231 in a blind-mating manner while adjusting the location of the auxiliary fixing device 21 relative to the supporting rod 2012 in the vertical direction. In other words, the use of the power connection mechanism 3 is helpful for directly connecting the modular electronic device 23 with the power distribution unit 22 in a blind-mating manner

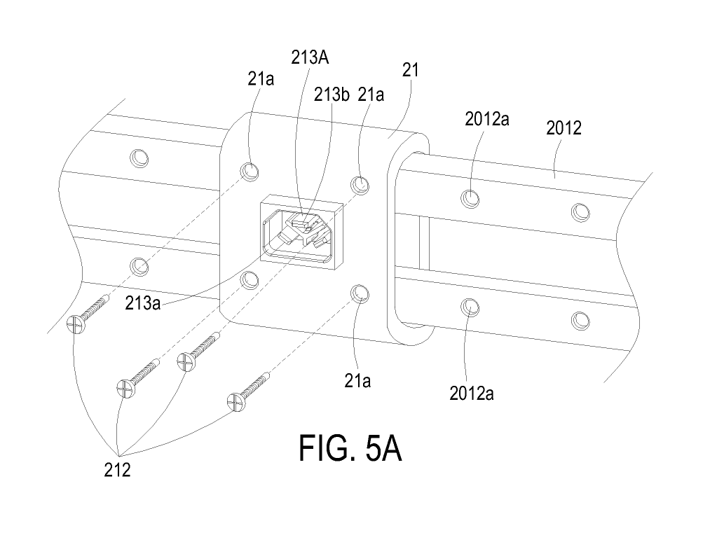

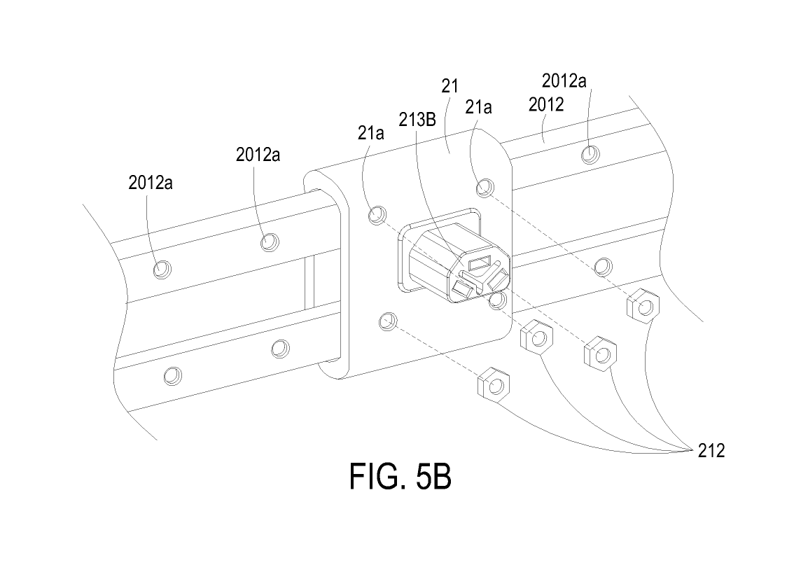

FIG. 5A is schematic rear view illustrating the auxiliary fixing device and the support rod of the data processing apparatus according to another embodiment of the present invention. FIG. 5B is schematic front view illustrating the auxiliary fixing device and the support rod of FIG. 5A. Please refer to FIGS. 3, 5A and 5B. In this embodiment, the auxiliary fixing device 21 further comprises a third electric connector 213. An example of the third electric connector 213 includes but is not limited to a female-to-male connector or a male-to-female connector. Moreover, the third electric connector 213 has guiding parts 213a and/or 213b. A first end 213A of the third electric connector 213 fits the first electric connector 222 of the power distribution unit 22. A second end 213B of the third electric connector 213 fits the second electric connector 231 of the modular electronic device 23. At the first time when the modular electronic device 23 is installed in the rack cabinet 20, the type of the third electric connector 213 is selected. Then, according to the location of the second electric connector 231 of the modular electronic device 23, a specified location of the third electric connector 213 of the auxiliary fixing device 21 relative to the supporting rod 2012 is determined. Then, the third electric connector 213 is positioned at the specified location, and the third electric connector 213 is connected with the first electric connector 222 of the power distribution unit 22. After the second electric connector 231 of the modular electronic device 23 is connected with the third electric connector 213 in a blind-mating manner, the first electric connector 222 of the power distribution unit 22 is in communication with the second electric connector 231 through the third electric connector 213.

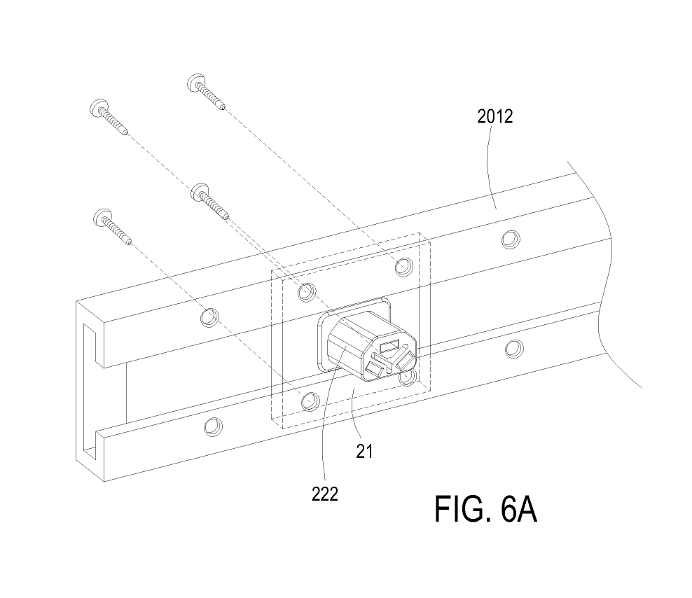

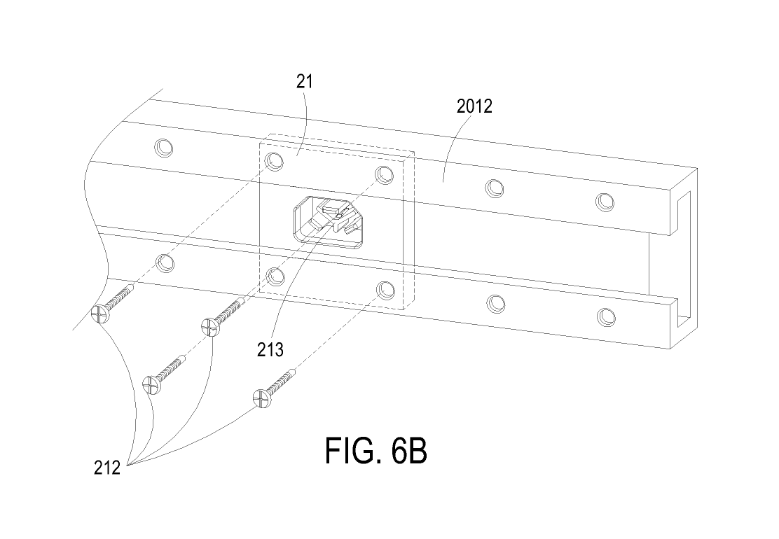

FIG. 6A schematically another exemplary auxiliary fixing device and the corresponding support rod according to an embodiment of the present invention. FIG. 6B schematically a further exemplary auxiliary fixing device and the corresponding support rod according to an embodiment of the present invention. In this embodiment, the auxiliary fixing device 21 is slab-shaped or block-shaped. In addition, the auxiliary fixing device 21 is embedded in the supporting rod 2012 and movably fixed at a specified location of the supporting rod 2012. In this embodiment, the supporting rod 2012 is C-shaped or U-shaped. Through the supporting rod 2012, the first electric connector 222 may be positioned at the specified location of the supporting rod 2012 (see FIG. 6A). Similarly, through supporting rod 2012, the third electric connector 213 may be positioned at the specified location of the supporting rod 2012 (see FIG. 6B). The operating principles and configurations of FIG. 6B are similar to those of the above embodiments, and are not redundantly described herein.

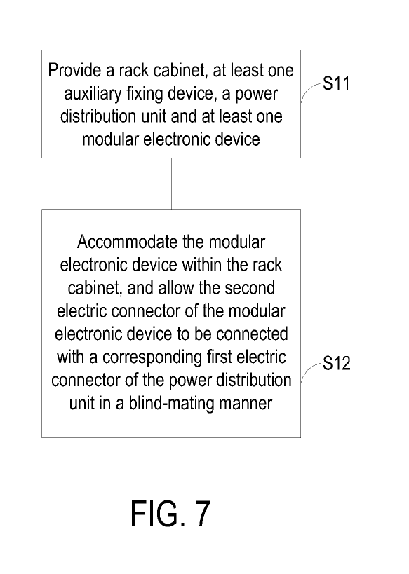

FIG. 7 is a flowchart illustrating a power connection method of the data processing apparatus according to an embodiment of the present invention. Please refer to FIGS. 2A, 3A, 3B and 7. Firstly, in the step S11, a rack cabinet 20, at least one auxiliary fixing device 21, a power distribution unit 22 and at least one modular electronic device 23 are provided. The rack cabinet 20 comprises a frame assembly 201 and a receiving part 202. The frame assembly 201 comprises a frame body 2011 and one or more supporting rods 2012. The power distribution unit 22 is disposed on the frame body 2011 of the frame assembly 201, and comprises a plurality of power cords 221 and a plurality of first electric connectors 222. The power cords 221 are connected with respective first electric connectors 222. The auxiliary fixing device 21 is used for assisting in positioning a corresponding first electric connector 222 at a specified location of a corresponding supporting rod 2012. The modular electronic device 23 comprises a second electric connector 231. Then, in the step S12, the modular electronic device 23 is swappable to be accommodated within the rack cabinet 20, wherein the second electric connector 231 of the modular electronic device 23 is connected with the corresponding first electric connector 222 of the power distribution unit 22 in a blind-mating manner.

From the above description, the present invention provides a data processing apparatus and a power connection mechanism thereof. According to the location of the electric connector of the modular electronic device, the location of the auxiliary fixing device is adaptively adjusted so that a corresponding electric connector is connected with the electric connector of the modular electronic device in a blind-mating manner. In such way, even if these modular electronic devices are acquired from several different manufacturers, the electric connectors of the modular electronic devices can be plugged into corresponding electric connectors in the blind-mating manner. For maintaining or replacing the modular electronic device, it is not necessary to move the rack cabinet to detach the power cords. After the modular electronic device is accommodated within the rack cabinet, the electric connector of the modular electronic device is directly connected with a corresponding electric connector. Consequently, it is labor-saving and time-saving to install and maintain the data processing apparatus.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data processing apparatus, comprising:
a rack cabinet comprising a frame assembly and a receiving part, wherein said frame assembly comprises a frame body and at least one supporting rod;
a power distribution unit disposed on said frame body of said frame assembly, and comprising a plurality of power cords and a plurality of first electric connectors, wherein said power cords are connected with respective first electric connectors;
at least one auxiliary fixing device for assisting in positioning a corresponding first electric connector at a specified location of said supporting rod; and
at least one modular electronic device comprising a second electric connector and swappable to be accommodated within a corresponding compartment of said receiving part, wherein after said modular electronic device is accommodated within said compartment, said second electric connector is connected with said corresponding first electric connector of said power distribution unit.

2. The data processing apparatus according to claim 1, wherein said auxiliary fixing device further comprises a perforation, and said first electric connector is detachably mounted in said perforation of said auxiliary fixing device.

3. The data processing apparatus according to claim 1, wherein said frame assembly further comprises at least one supporting post, wherein said supporting post is fixed on the frame body and perpendicular to said supporting rod.

4. The data processing apparatus according to claim 1, wherein said modular electronic device is a computer or a server.

5. The data processing apparatus according to claim 1, wherein said first electric connectors of said power distribution unit and said second electric connector of said modular electronic device are IEC connectors.

6. The data processing apparatus according to claim 5, wherein said first electric connector and said second electric connector are respectively an IEC C13 connector and an IEC C14 connector, or said first electric connector and said second electric connector are respectively an IEC C15 connector and an IEC C16 connector.

7. The data processing apparatus according to claim 1, wherein at least one of said first electric connectors of said power distribution unit and said second electric connector of said modular electronic device has a guiding part.

8. The data processing apparatus according to claim 1, wherein said auxiliary fixing device further comprises a plurality of fixing elements for facilitating positioning said auxiliary fixing device at a specified location of said supporting rod.

9. The data processing apparatus according to claim 1, wherein said auxiliary fixing device is movable on said supporting rod in a horizontal direction.

10. The data processing apparatus according to claim 1, wherein said auxiliary fixing device is movable on said supporting rod in a vertical direction.

11. The data processing apparatus according to claim 1, wherein said auxiliary fixing device further comprises a third electric connector, wherein a first end of said third electric connector fits said first electric connector of said power distribution unit, and a second end of said third electric connector fits said second electric connector of said modular electronic device.

12. The data processing apparatus according to claim 11, wherein said third electric connector has at least one guiding part.

13. The data processing apparatus according to claim 11, wherein said third electric connector is a female-to-male connector or a male-to-female connector.

14. The data processing apparatus according to claim 1, wherein said modular electronic device further comprises a power supply unit.

15. The data processing apparatus according to claim 1, wherein said modular electronic device further comprises a communication module and a controlling module.

16. A power connection mechanism of a data processing apparatus, said data processing apparatus comprising a rack cabinet with a frame assembly and a receiving part, said frame assembly comprising a frame body and at least one supporting rod, said power connection mechanism comprising:
a power distribution unit disposed on said frame body of said frame assembly, and comprising a plurality of power cords and a plurality of first electric connectors, wherein said power cords are connected with respective first electric connectors;
at least one auxiliary fixing device for assisting in positioning a corresponding first electric connector at a specified location of said supporting rod; and
at least one modular electronic device comprising a second electric connector and swappable to be accommodated within a corresponding compartment of said receiving part, wherein after said modular electronic device is accommodated within said compartment, said second electric connector is connected with said corresponding first electric connector of said power distribution unit in a blind-mating manner.

17. A power connection method, comprising:
providing a rack cabinet, at least one auxiliary fixing device, a power distribution unit and at least one modular electronic device, wherein said rack cabinet comprises a frame assembly and a receiving part, said frame assembly comprises a frame body and at least one supporting rod, said power distribution unit is disposed on said frame body of said frame assembly and comprises a plurality of power cords and a plurality of first electric connectors, said power cords are connected with respective first electric connectors, said auxiliary fixing device is configured for assisting in positioning a corresponding first electric connector at a specified location of said supporting rod, and said modular electronic device comprises a second electric connector; and
accommodating said modular electronic device within said rack cabinet, and allowing said second electric connector of said modular electronic device to be connected with a corresponding first electric connector of said power distribution unit.
